(19) United States
(12) Patent Application Publication
(10) Pub. No.: US 2026/0319180 A1
(43) Pub. Date: Oct. 15, 2026

(54) Communications Circuitry with Isolator-Free Optical Injection Locking

(71) Applicant: Apple Inc., Cupertino, CA (US)

(72) Inventors: Nedim Muharemovic, Nuremberg (DE); Zdravko Boos, Munich (DE); Bertram R Gunzelmann, Koenigsbrunn (DE); Thomas Mayer, Linz (AT)

(21) Appl. No.: 19/178,618

(22) Filed: Apr. 14, 2025

(51) Int. Cl. G02B 6/28; G02B 6/12

(52) U.S. Cl. CPC G02B 6/2813; G02B 6/12019

(57) ABSTRACT

An electronic device may include communication circuity that conveys signals using with a first laser that outputs a first optical signal and a second laser that outputs a second optical signal. The communication circuitry may include a multi-mode interference (MMI) coupler having first and second input ports and first and second output ports. The first laser may provide the first optical signal to the first input port. The second laser may provide the second optical signal to the second input port. The MMI coupler may be configured to exhibit a phase relationship between its ports that isolates the first and second lasers. One or two optical resonators may self-injection lock the lasers. The optical signals may exhibit low phase noise and jitter without the use of bulky optical isolators in the electronic device.

### FIELD

This disclosure relates generally to electronic devices, including electronic devices with communications circuitry.

### BACKGROUND

Electronic devices can be provided with signal transmission capabilities. An electronic device with signal transmission capabilities has communications circuitry that conveys signals.

As software applications on electronic devices become more data-intensive over time, demand has grown for electronic devices that support communications at higher data rates. However, the maximum data rate supported by electronic devices is limited by the frequency of the transmitted signals. As communication frequencies increase, it can become more difficult to provide compact and low phase noise clocking for the communications circuitry.

### SUMMARY

An electronic device may include communication circuity. The communication circuitry may include signal generation circuitry. The signal generation circuitry may include a first laser that outputs a first optical signal and a second laser that outputs a second optical signal at a different frequency than the first optical signal. The communication circuitry may perform signal transmission and/or reception based on the first optical signal, the second optical signal, or an electrical signal generated using the first and second optical signals.

The signal generation circuitry may include a multi-mode interference (MMI) coupler having first and second input ports and first and second output ports. The first laser may provide the first optical signal to the first input port. The second laser may provide the second optical signal to the second input port. The MMI coupler may pass the first and second optical signals onto the first and second output ports. The MMI coupler may be configured to exhibit a first phase at the first input port, a second phase at the second input port that is 180 degrees from the first phase, a third phase at the first output port, and a fourth phase at the second output port. This phase relationship may serve to isolate the first laser from the second laser.

One or more optical resonators may be used to self-injection lock the first and second lasers. For example, a first optical resonator may be coupled between the first laser and the first input port of the MMI coupler to self-injection lock the first laser and a second optical resonator may be coupled between the second laser and the second input port of the MMI coupler to self-injection lock the second laser. As another example, a single optical resonator may be coupled to the first output port of the MMI coupler and may self-injection lock both the first laser and the second laser through the MMI coupler. If desired, a phase-locked loop may be coupled between the second output port of the MMI coupler and an actuator on the one or more optical resonators. In this way, the communication circuitry may convey signals with reduced phase noise and jitter without requiring the bulky optical isolators in the signal generation circuitry.

An aspect of the disclosure provides communication circuitry. The communication circuitry can include a first laser. The communication circuitry can include a second laser. The communication circuitry can include a multi-mode interference (MMI) coupler having a first input port, a second input port, a first output port, and a second output port. The communication circuitry can include a first optical path that couples an output of the first laser to the first input port of the MMI coupler. The communication circuitry can include a second optical path that couples an output of the second laser to the second input port of the MMI coupler. The communication circuitry can include a first optical resonator disposed on the first optical path.

An aspect of the disclosure provides communication circuitry. The communication circuitry can include a first laser. The communication circuitry can include a second laser. The communication circuitry can include a multi-mode interference (MMI) coupler having a first input port, a second input port, a first output port, and a second output port. The communication circuitry can include a first optical path that couples an output of the first laser to the first input port of the MMI coupler. The communication circuitry can include a second optical path that couples an output of the second laser to the second input port of the MMI coupler. The communication circuitry can include an optical resonator coupled to the first output port of the MMI coupler.

An aspect of the disclosure provides an electronic device. The electronic device can include a multi-mode interference (MMI) coupler having a first input port, a second input port that exhibits a 180 degree phase difference from the first input port, a first output port, and a second output port that exhibits an inverse phase of the first output port. The electronic device can include a first laser configured to supply a first optical signal at a first frequency to the first input port of the MMI coupler. The electronic device can include a second laser configured to supply a second optical signal at a second frequency to the second input port of the MMI coupler, wherein the MMI coupler is configured to output the first optical signal and the second optical signal at the first output port. The electronic device can include circuitry configured to convey data based on the first optical signal and the second optical signal output at the first output port by the MMI coupler. The electronic device can include one or more optical resonators configured to self-injection lock the first laser and the second laser.

### BRIEF DESCRIPTION OF THE DRAWINGS

FIG. 1 is a block diagram of an illustrative electronic device having communications circuitry in accordance with some embodiments.

FIG. 2 is a circuit diagram of illustrative signal generation circuitry that includes light sources, first and second optical resonators, and a multi-mode interference coupler that isolates the light sources in accordance with some embodiments.

FIG. 3 is a circuit diagram of illustrative signal generation circuitry that includes light sources, a multi-mode interference coupler, and an optical resonator that is shared by the light sources in accordance with some embodiments.

FIG. 4 is a plot showing how illustrative signal generation circuitry of the type shown in FIG. 3 may reduce phase noise in a generated signal in accordance with some embodiments.

FIG. 5 is a flow chart of illustrative operations involved in transmitting signals in accordance with some embodiments.

### DETAILED DESCRIPTION

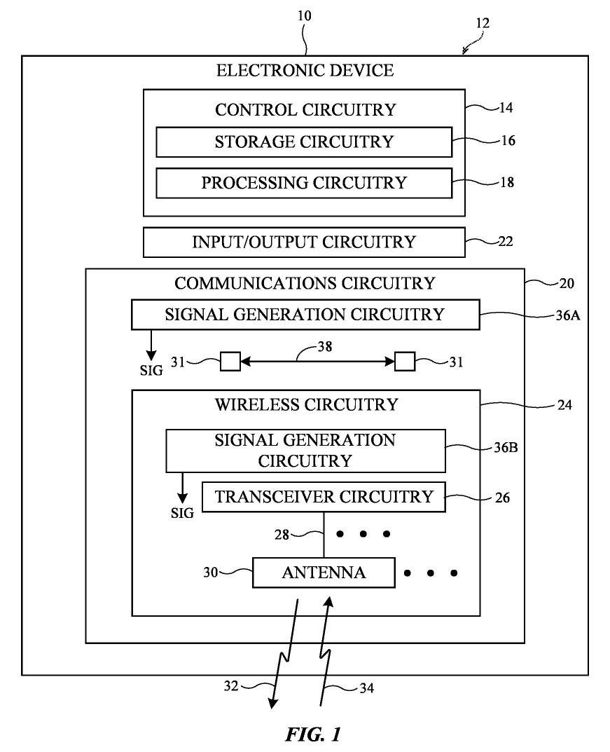

Electronic device 10 of FIG. 1 may be a computing device such as a laptop computer, a desktop computer, a computer monitor (e.g., containing an embedded computer), a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user’s head (e.g., a virtual, augmented, mixed, or extended reality headset or head-mounted display device), or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, an integrated circuit package, a computer motherboard, a graphics processing chip, a server, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which is sometimes also referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols – sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol. Control circuitry 14 may also be used in implementing wired communications protocols.

Device 10 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (e.g., accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Device 10 may also include communications circuitry 20 for transmitting, conveying, and/or receiving signals between device 10 and external equipment such as one or more external devices (e.g., other devices such as device 10 or other types of communications equipment) and/or between components within device 10. Communications circuitry 20 is sometimes also referred to as communication circuitry 20. If desired, communications circuitry 20 may include wireless circuitry 24 to support wireless communications. Wireless circuitry 24 (sometimes referred to herein as wireless communications circuitry 24) may include one or more antennas 30 (e.g., antenna elements).

Wireless circuitry 24 may also include transceiver circuitry 26. Transceiver circuitry 26 may include transmitter circuitry, receiver circuitry, modulator circuitry, photomixers, demodulator circuitry (e.g., one or more modems), radio-frequency circuitry, one or more radios, intermediate frequency circuitry, optical transmitter circuitry, optical receiver circuitry, optical light sources, other optical components, baseband circuitry (e.g., one or more baseband processors), amplifier circuitry, clocking circuitry such as one or more local oscillators and/or phase-locked loops, memory, one or more registers, filter circuitry, switching circuitry, analog-to-digital converter (ADC) circuitry, digital-to-analog converter (DAC) circuitry, radio-frequency transmission lines, optical fibers, and/or any other circuitry for transmitting and/or receiving wireless signals using antennas 30. The components of transceiver circuitry 26 may be implemented on one integrated circuit, chip, system-on-chip (SOC), die, printed circuit board, substrate, or package, or the components of transceiver circuitry 26 may be distributed across two or more integrated circuits, chips, SOCs, printed circuit boards, substrates, and/or packages.

Wireless communications performed by wireless circuitry 24 may include or involve wireless data communications (e.g., where wireless data is carried by radio-frequency signals conveyed between wireless circuitry 24 and other communications equipment bidirectionally or unidirectionally), radio-frequency signal transmission, radio-frequency signal reception, and/or radio-based spatial ranging/sensing (e.g., radio detection and ranging (radar) operations, shorter range object detection such as near-field radio-frequency signal-based object detection, etc.). Radio-frequency signals conveyed by wireless circuitry 24 may include or carry wireless data (e.g., organized into frames, packets, symbols, datagrams, etc.), radar or other spatial ranging waveforms, continuous wave signals, chirp signals, control signals, management signals, reference signals, beacon signals, tones, pulses/impulses, waveforms associated with one or more communications protocols, and/or any other radio-frequency waveforms or signals. Wireless circuitry 24 is sometimes also referred to herein as wireless communications circuitry 24, wireless communication circuitry 24, communications circuitry 24, or simply as circuitry 24. Some or all of the signal generation, transmission, and/or reception operations described herein as being performed by wireless circuitry 24 may alternatively be performed by wired communications circuitry in input-output circuitry 20.

The example of FIG. 1 is illustrative and non-limiting. Although control circuitry 14 is shown separately from communications circuitry 20 in the example of FIG. 1 for the sake of clarity, communications circuitry 20 and/or wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of wireless circuitry 24 and/or communications circuitry 20. The baseband circuitry may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

Transceiver circuitry 26 may be coupled to each antenna 30 in wireless circuitry 24 over a respective signal path 28. Each signal path 28 may include one or more radio-frequency transmission lines, waveguides, optical paths, optical fibers, optical waveguides, and/or any other desired lines/paths for conveying wireless signals between transceiver circuitry 26 and antenna 30. Antennas 30 may be formed using any desired antenna structures for conveying wireless signals. For example, antennas 30 (e.g., antenna elements) may include resonating elements (radiators) that are formed from dipole antenna structures, planar dipole antenna structures (e.g., bowtie antenna structures), slot antenna structures, loop antenna structures, patch antenna structures, inverted-F antenna structures, planar inverted-F antenna structures, helical antenna structures, monopole antennas, dipoles, hybrids of these designs, or any other antenna types. Filter circuitry, switching circuitry, impedance matching circuitry, and/or other antenna tuning components may be adjusted to adjust the frequency response and wireless performance of antennas 30 over time.

If desired, two or more of antennas 30 may be integrated into a phased antenna array (sometimes referred to herein as a phased array antenna) in which each of the antennas conveys wireless signals with a respective phase and magnitude that is adjusted over time so the wireless signals constructively and destructively interfere to produce (form) a signal beam in a given pointing direction. The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally, or alternatively, receive the wireless signals from free space (e.g., through intervening devices structures such as a dielectric cover layer). The transmission and reception of wireless signals by antennas 30 each involve the excitation or resonance of currents on an antenna resonating (radiating) element in the antenna by signals within the frequency band(s) of operation of the antenna.

Transceiver circuitry 26 may use antenna(s) 30 to transmit and/or receive wireless signals that convey wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data symbols, packets, datagrams, and/or frames such as wireless data associated with a telephone call, streaming media content, internet browsing, wireless data associated with software applications running on device 10, email messages, etc.

Additionally, or alternatively, wireless circuitry 24 may use antenna(s) 30 to perform wireless sensing operations. The sensing operations may allow device 10 to detect (e.g., sense or identify) the presence, location, orientation, and/or velocity (motion) of objects external to device 10 (e.g., using a radar scheme or another spatial ranging scheme). Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user’s hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc.

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands (e.g., between 10-300 GHz), near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Communications circuitry on the electronic devices therefore needs to support data transfer at higher and higher data rates. In general, the data rates supported by the communications circuitry are proportional to the frequency of the signals conveyed by the communications circuitry (e.g., higher frequencies can support higher data rates than lower frequencies). Communications circuitry 20 may convey centimeter and millimeter wave signals to support relatively high data rates (e.g., because centimeter and millimeter wave signals are at relatively high frequencies between around 10 GHz and 300 GHz). However, the data rates supported by centimeter and millimeter wave signals may still be insufficient to meet all the data transfer needs of device 10. To support even higher data rates such as data rates up to 5-10 Gbps or higher, communications circuitry 20 may convey wireless signals at frequencies greater than around 100 GHz.

As shown in FIG. 1, wireless circuitry 24 may transmit wireless signals 32 and may receive wireless signals 34. Wireless signals 32 and 34 may be conveyed at frequencies greater than around 100 GHz if desired (sometimes also referred to as tremendously high frequency (THF) frequencies). When conveyed at frequencies greater than about 100 GHz, wireless signals 32 and 34 are sometimes also referred to herein as THF signals, sub-THz signals, THz signals, or sub-millimeter wave signals. THF signals conveyed by wireless circuitry 24 may be at sub-THz or THz frequencies such as frequencies between about 100 GHz and about 1 THz, between about 100 GHz and about 10 THz, between 100 GHz and 2 THz, between 200 GHz and 1 THz, between 300 GHz and 1 THz, between 300 GHz and 2 THz, between 300 GHz and 10 THz, between 100 GHz and 800 GHz, between 200 GHz and 1.5 THz, etc. (e.g., within a sub-THz, THz, THF, or sub-millimeter frequency band such as a 3GPP Sixth Generation (6G) frequency band).

The high data rates supported by these frequencies may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna 30 on a first chip in device 10 transmits wireless signals 32 to another antenna 30 on a second chip in device 10), and/or to perform any other desired high data rate operations. Wireless circuitry 24 may include one or more antennas 30 that convey THF signals (e.g., at frequencies greater than around 100 GHz) and/or may include one or more antennas 30 that convey non-THF signals (e.g., at frequencies less than around 100 GHz). These examples are illustrative and, if desired, wireless circuitry 24 may convey wireless signals 32 and 34 in other frequency bands.

Communications circuitry 20 may include signal generation circuitry 36. Signal generation circuitry 36 may generate and output a signal (SIG) at relatively high frequencies. Signal SIG may be, for example, a radio-frequency signal at frequencies between around 600 MHz and around 10 THz or may be an optical signal at optical frequencies (e.g., visible frequencies, infrared or near infrared frequencies, ultraviolet frequencies, etc.). Communications circuitry 20 may use signal SIG to convey wireless data (or other signals that do not carry wireless data) with an external device. The high frequency of signal SIG may serve to maximize the data rate with which communications circuitry 20 conveys wireless data with the external device.

Signal generation circuitry 36 may, for example, include digital, analog, and/or optical clocking circuitry that generates signal SIG. Communications circuitry 20 may use signal SIG to clock signal transmission and/or reception by device 10 (e.g., signal SIG may be a clocking signal such as an electrical or optical local oscillator signal). The clocking circuitry may include one or more oscillators (e.g., reference oscillators, crystal oscillators, voltage controlled oscillators, etc.), phase locked loops (PLLs), frequency locked loops (FLLs), self-injection-locking loops, and/or other clocking circuitry that generates signal SIG. Signal generation circuitry 36 is sometimes also referred to herein as clocking circuitry 36 or signal generator 36.

If desired, communications circuitry 20 may use signal SIG to upconvert and/or downconvert an additional signal between different frequencies (e.g., by providing signal SIG and the additional signal to mixer circuitry that upconverts or downconverts the additional signal to a desired frequency by mixing the additional signal with signal SIG). The additional signal may carry data (e.g., a stream of data bits organized into a corresponding data structure such as a packet, frame, symbol, datagram, etc.).

As another example, communications circuitry 20 may modulate data onto signal SIG itself and the modulated signal may be transmitted to an external device and/or may be used to generate other signals that are transmitted to an external device. As another example, communications circuitry 20 may receive a signal that carries modulated data and may use signal SIG to convert, demodulate, mix, and/or otherwise process the received signal carrying the modulated data. In general, signal SIG may be any desired signal that is transmitted by communications circuitry 20 to an external device, that is used by communications circuitry 20 to transmit other signals to an external device, that is used by communications circuitry 20 to receive other signals from an external device, that is transmitted between components 31 in device 10, that is used to transmit another signal between components 31 in device 10, or that is used to receive another signal between components 31 in device 10. One or more of components 31 may be formed within wireless circuitry 24, within transceiver circuitry 26, within input/output devices 22, or within control circuitry 14 if desired.

Signal generation circuitry 36 may include electro-optical (EO) signal generation circuitry or may include electrical signal generation circuitry. EO signal generation circuitry (e.g., EO clocking circuitry) in signal generation circuitry 36 may generate signal SIG in the optical domain (e.g., signal SIG may be an optical signal such as an optical local oscillator signal) or in the electrical domain (e.g., signal SIG may be an electrical signal such as a radio-frequency signal). The EO signal generation circuitry may include one or more electro-optical phase locked loops (EOPLLs), EO FLLs, and/or EO self-injection-locking loops if desired. Electrical signal generation circuitry in signal generation circuitry 36 may generate signal SIG in the electrical domain (e.g., at radio frequencies).

If desired, signal generation circuitry 36 may include signal generation circuitry 36B in wireless circuitry 24. Wireless circuitry 24 may use signal generation circuitry 36B to transmit wireless signals 32 and/or to receive wireless signals 34 using transceiver circuitry 26 and antenna(s) 30. Signal generation circuitry 36B may be included within transceiver circuitry 26 or may be external to transceiver circuitry 36B. Signal generation circuitry 36B may provide signal SIG to one or more mixers, photomixers (e.g., photodiodes), and/or other circuitry in transceiver circuitry 26, for example.

If desired, signal generation circuitry 36 may include signal generation circuitry 36A in communications circuitry 20 but external to wireless circuitry 24. Communications circuitry 20 may use signal generation circuitry 36A to convey electrical or optical signals over a signal path 38 between components 31 in communications circuitry 20. Signal path 38 may be a wired signal path (e.g., a radio-frequency transmission line path that conveys electrical signals or an optical path that conveys optical signals). Components 31 may be any desired components in communications circuitry 20 and/or device 10.

As one example, a first component 31 may generate a signal that includes or that is based on (e.g., clocked using) the signal SIG generated by signal generation circuitry 36A and may transmit the generated signal to a second component 31 over signal path 38. The second component 31 may be, for example, an electrical connector (e.g., a radio-frequency connector) that is coupled to an external device over an external electrical signal path (e.g., a cable or radio-frequency transmission line). The electrical connector may transmit the signal from signal path 38 to the external device over the external signal path. Alternatively, the second component 31 may be an optical connector that is coupled to the external device over an external optical signal path (e.g., an optical fiber or waveguide). The optical connector may transmit the signal from signal path 38 to the external device over the external signal path.

Conversely, the second component 31 may be an electrical connector that receives an electrical signal from the external device over an external electrical signal path or may be an optical connector that receives an optical signal from the external device over an external optical signal path. The second component 31 may transmit the electrical or optical signal to the first component 31 over signal path 38. The first component 31 may receive and process (e.g., downconvert, upconvert, mix, etc.) the electrical or optical signal using the signal SIG generated by signal generation circuitry 36A. If desired, wireless circuitry 24 may be omitted from device 10 (e.g., device 10 need not convey wireless signals).

If desired, one or more mixers in communications circuitry 20 may receive signal SIG for converting other signals between different frequencies (e.g., between baseband frequencies, intermediate frequencies, radio frequencies, optical frequencies, etc.). The mixers may include one or more radio mixers (e.g., for converting between radio, intermediate, and/or baseband frequencies) and/or one or more electro-optical (EO) mixers (e.g., for converting between radio frequencies and optical frequencies or between optical frequencies). The EO mixers are sometimes referred to herein as photomixers and may include photodiodes (e.g., uni-travelling-carrier photodiodes (UTC PDs) or other types of programmable photodiodes), electrooptical modulators (e.g., Mach-Zehnder modulators), and/or other mixers that convert signals from radio frequencies to optical frequencies and/or from optical frequencies to radio frequencies.

When signal SIG is used to convey wired and/or wireless signals at relatively high frequencies (e.g., radio frequencies greater than around 10-100 GHz, optical frequencies, etc.), if care is not taken, signal SIG can exhibit excessive phase noise and/or jitter. Excessive phase noise and jitter can undesirably deteriorate the wired and/or wireless signals conveyed between device 10 and the external device. Phase noise and jitter is also particularly sensitive to temperature. Variations in temperature can produce different amounts of phase noise and jitter. Additional devices such as thermo-electrical coolers (e.g., Peltier elements) can be used to help control the temperature of communications circuitry 20 and thus phase noise and jitter, but can be excessively bulky, expensive, and power hungry.

To help mitigate these issues, signal generation circuitry 36 may include one or more self-injection locking loops with light sources and one or more resonators (cavities) that are used to mitigate phase noise and jitter across operating temperatures (e.g., without requiring additional bulky temperature control devices such as thermo-electrical coolers). In implementations that are described herein as an example, the light sources may include lasers and the resonator(s) may include optical resonator(s). The optical resonator(s) may be used to perform self-injection locking of the laser(s).

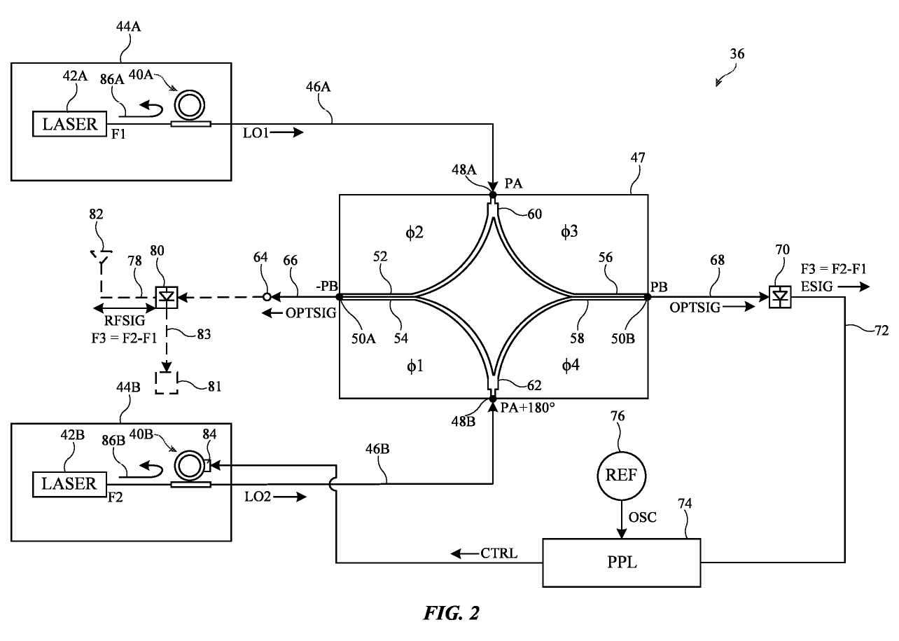

FIG. 2 is a circuit diagram showing one example of signal generation circuitry 36 in implementations where the signal generation circuitry includes first and second lasers that are self-injection locked to respective optical resonators (cavities). As shown in FIG. 2, signal generation circuitry 36 (e.g., EO signal generation circuitry) may include a first light source such as laser 42A and may include a second light source such as laser 42B. Laser 42A may have an optical output that is optically coupled to a first optical path 46A. Laser 42B may have an optical output that is optically coupled to a second optical path 46B.

Laser 42A may have an electrical (control) input that receives a first bias current that controls (biases) laser 42A. The first bias current may, for example, control laser 42A to generate and emit, onto optical path 46A, a first optical signal such as optical local oscillator signal LO1 at frequency F1. Additionally, or alternatively, laser 42A may be controlled by a corresponding bias voltage (e.g., the first bias current may be replaced by a first bias voltage that controls laser 42A to output optical local oscillator signal LO1). Similarly, laser 42B may have an electrical (control) input that receives a second bias current that controls (biases) laser 42B. The second bias current may, for example, control laser 42B to generate and emit, onto optical path 46B, a second optical signal such as optical local oscillator signal LO2 at frequency F2. Additionally, or alternatively, laser 42B may be controlled by a corresponding bias voltage (e.g., the second bias current may be replaced by a second bias voltage that controls laser 42N to output optical local oscillator signal LO2). Frequencies F2 and F1 are in the optical domain (e.g., corresponding to wavelengths shorter than or equal to infrared wavelengths). Frequency F2 may be different than frequency F1 (e.g., may be separated from frequency F1 by a frequency gap having a width equal to a radio frequency such as a sub-THz frequency). Optical local oscillator signal LO1, optical local oscillator signal LO2, an optical signal containing both optical local oscillator signals LO1 and LO2, and/or an electrical signal generated by signal generation circuitry 36 using optical local oscillator signals LO1 and LO2 may form signal SIG of FIG. 1.

If desired, laser 42A may be integrated into and/or disposed on a corresponding first laser module 44A. The components of laser module 44A may, for example, be disposed on a first shared substrate such as a printed circuit board substrate, a package substrate, a semiconductor substrate, an integrated circuit chip, a photonic integrated circuit, etc. Similarly, if desired, laser 42B may be integrated into and/or disposed on a corresponding second laser module 44B that is different from first laser module 44A. The components of laser module 44B may, for example, be disposed on a second shared substrate such as a printed circuit board substrate, a package substrate, a semiconductor substrate, an integrated circuit chip, a photonic integrated circuit, etc.

In practice, if care is not taken, a laser such as laser 42A or laser 42B tends to drift into an unstable state when power from the optical signal output by the laser reflects back towards the laser. For example, the reflected power can degrade signal-to-noise ratio (SNR) of the optical signal and can cause the laser to output the optical signal with multiple different oscillations at different frequencies. To help mitigate these issues, the laser can be locked to an optical resonator. The optical resonator may be adjusted and/or tuned to provide robust operation for the laser without sacrificing noise performance.

For example, as shown in FIG. 2, signal generation circuitry 36 may include a first optical resonator 40A disposed on optical path 46A (e.g., for locking to laser 42A) and may include a second optical resonator 40B disposed on optical path 46B (e.g., for locking to laser 42B). If desired, optical resonator 40A may be integrated into and/or disposed on laser module 44A. If desired, optical resonator 40B may be integrated into and/or disposed on laser module 44B. Optical resonators 40A and 40B are non-magnetic optical resonators (unlike optical isolators) and are therefore sometimes also referred to herein as non-magnetic optical resonators 40A and 40B. Optical resonators 40A and 40B may, for example, each be an optical micro-resonator (MR) that contains a corresponding resonant optical cavity such as a resonant optical loop (e.g., a loop or ring of optical fiber or waveguide, sometimes also referred to as an optical micro-loop).

The resonant optical loop of optical resonator 40A may be optically coupled to optical path 46A. Optical resonator 40A may receive optical local oscillator signal LO1 from the output of laser 42A (e.g., over a first portion of optical path 46A). The optical loop in optical resonator 40A may carry optical local oscillator signal LO1 in a set of optical resonances each at a corresponding optical resonant wavelength. The set of optical resonances is sometimes also referred to as an optical comb, a wavelength comb, or a frequency comb of the optical resonator. The physical dimensions of the optical loop (e.g., the radius or diameter of the optical loop) may establish the particular optical resonances (resonant wavelengths) of the optical comb for the optical resonator.

Optical local oscillator signal LO1 may be incident upon an input port of optical resonator 40A from laser 42A (e.g., via the first portion of optical path 46A). The wavelength of optical local oscillator signal LO1 (corresponding to frequency F1) may match one or more resonant wavelengths of the optical loop in optical resonator 40A, causing the optical local oscillator signal to be coupled off of optical path 46A and onto the optical loop of optical resonator 40A, to resonate around the optical loop in optical resonator 40A, and to be coupled off of the optical loop and back onto optical path 46A. Optical resonator 40A may output only wavelength(s) of optical local oscillator signal LO1 matching its resonant wavelength(s) via a corresponding output port of optical resonator 40A (e.g., a port of optical resonator 40A coupled to a second portion of optical path 46A). In this way, optical resonator 40A may also serve as an optical filter for optical local oscillator signal LO1.

At the same time, at least some of the optical local oscillator signal LO1 received at the input port of optical oscillator 40A may be reflected by the optical loop in optical resonator 40A back towards the optical output of laser 42A (e.g., over the first portion of optical path 46A). For example, the wavelength(s) of optical local oscillator signal LO1 matching the wavelength(s) of the optical resonance(s) of the optical loop in optical resonator 40A may be reflected back towards laser 42A. As shown by arrow 86A, the reflected portion of optical local oscillator signal LO1 may be injected back into the cavity of laser 42A (e.g., via the optical output of laser 42A), which may serve to self-injection lock the laser to an optical resonance (and corresponding resonant wavelength) of optical resonator 40A.

Similarly, the resonant optical loop of optical resonator 40B may be optically coupled to optical path 46B. Optical resonator 40B may receive optical local oscillator signal LO2 from the output of laser 42B (e.g., over a first portion of optical path 46B). The optical loop in optical resonator 40B may carry optical local oscillator signal LO2 in a set of optical resonances each at a corresponding optical resonant wavelength. Optical local oscillator signal LO2 may be incident upon an input port of optical resonator 40B from laser 42B (e.g., via the first portion of optical path 46B). The wavelength of optical local oscillator signal LO2 (e.g., corresponding to frequency F2) may match one or more resonant wavelengths of the optical loop in optical resonator 40B, causing the optical local oscillator signal to be coupled off of optical path 46B and onto the optical loop of optical resonator 40B, to resonate around the optical loop in optical resonator 40B, and to be coupled off of the optical loop and back onto optical path 46B. Optical resonator 40B may output its resonant wavelength(s) of optical local oscillator signal LO2 at a corresponding output port of optical resonator 40B (e.g., a port of optical resonator 40B coupled to a second portion of optical path 46B). In this way, optical resonator 40B may also serve as an optical filter for optical local oscillator signal LO2.

At the same time, at least some of the optical local oscillator signal LO2 received at the input port of optical oscillator 40B may be reflected by the optical loop in optical resonator 40B back towards the optical output of laser 42B (e.g., over the first portion of optical path 46B). For example, the wavelength(s) of optical local oscillator signal LO2 matching the wavelength(s) of the optical resonance(s) of the optical loop in optical resonator 40B may be reflected back towards laser 42B. As shown by arrow 86B, the reflected portion of optical local oscillator signal LO2 may be injected back into the cavity of laser 42B (e.g., via the optical output of laser 42B), which may serve to self-injection lock the laser to an optical resonance (and corresponding resonant wavelength) of optical resonator 40B.

If desired, optical resonator 40B may include a mechanical actuator such as actuator 84. Actuator 84 may be coupled to the optical ring of optical resonator 40B. Actuator 84 may receive an electrical signal such as control signal CTRL (e.g., a voltage or current signal). Control signal CTRL may cause actuator 84 to mechanically adjust the physical dimensions (e.g., diameter, radius, width, length, etc.) of the optical loop in optical resonator 40B. This adjustment may change the resonant wavelength(s) of the optical resonance(s) in the optical comb of the optical loop in optical resonator 40B (e.g., to tune self-injection locking and/or frequency F2 of optical local oscillator signal LO2). Actuator 84 may include an electromechanical actuator such as a piezoelectric actuator, a microelectromechanical systems (MEMS) actuator, thermal circuitry, a PN junction, or another type of actuator.

Although optical resonators 40A and 40B may help to isolate laser 42A from the effect of its own optical local oscillator signal reflections and may help to isolate laser 42 from the effect of its own optical local oscillator signal reflections, signal generation circuitry 36 may require additional components to provide sufficient isolation between lasers 42A and 42B (e.g., to isolate laser 42A from the optical local oscillator signal LO2 output by laser 42B and/or to isolate laser 42B from the optical local oscillator signal LO1 output by laser 42A). In some scenarios, optical isolators such as a first optical isolator disposed on optical path 46A and/or a second optical isolator disposed on optical path 46B can be used to isolate lasers 42A and 42B from each other. Optical isolators are magnetic components that include a propagation medium and a magnet that causes the propagation medium to only propagate optical signals in a single direction (e.g., away from the corresponding laser). Although this may help to isolate one laser from power of the optical local oscillator signal output by another laser, optical isolators are very bulky (e.g., consuming areas on the order of several centimeters by several centimeters) and may generally be suited for a laboratory bench, but are otherwise unable to fit within compact electronic devices such as device 10 (FIG. 1).

To help isolate lasers 42A and 42B from each other without the use of optical isolators, signal generation circuitry 36 may include an optical multi-mode interference (MMI) coupler such as MMI coupler 47 (e.g., there may be no optical isolators included within signal generation circuitry 36 or device 10). MMI coupler 47, illustrated by an exploded view in FIG. 2 for the sake of clarity, may have a very small footprint in signal generation circuitry 36, such as an area that is less than or equal to around 30 microns by 30 microns.

MMI coupler 47 may be at least a two-by-two MMI coupler having two optical input ports 48 such as input ports 48A and 48B and having two optical output ports 50 such as output ports 50A and 50B. Input ports 48A and 48B are sometimes also referred to herein as optical input ports 48A and 48B, optical input terminals 48A and 48B, or input terminals 48A and 48B of MMI coupler 47. Output ports 50A and 50B are sometimes also referred to herein as optical output ports 50A and 50B, optical output terminals 50A and 50B, or output terminals 50A and 50B of MMI coupler 47.

As shown in FIG. 2, optical path 46A may optically couple laser 42A to input port 48A of MMI coupler 47 (e.g., the second portion of optical path 46A may couple the output port of optical resonator 40A to input port 48A of MMI coupler 47). Optical path 46B may optically couple laser 42B to input port 48B of MMI coupler 47 (e.g., the second portion of optical path 46B may couple the output port of optical resonator 40B to input port 48B of MMI coupler 47). Signal generation circuitry 36 may also include an optical path 66 coupled to output port 50A of MMI coupler 47 and/or an optical path 68 coupled to output port 50B of MMI coupler 47. Optical path 46A may propagate optical local oscillator signal LO1 from the output port of optical resonator 40A to input port 48A of MMI coupler 47. Optical path 46B may propagate optical local oscillator signal LO2 from the output port of optical resonator 40B to input port 48B of MMI coupler 47. Optical paths 46A, 46B, 66, and 68 may each include one or more optical fibers, waveguides, channels, lenses, and/or other optical path components that propagate light over or along the optical paths.

MMI coupler 47 may include an optical splitter 60 that is optically coupled to input port 48A (e.g., input port 48A may illuminate optical splitter 60 using the optical local oscillator signal LO1 on optical path 46A). Alternatively, optical splitter 60 may be integrated into input port 48A (e.g., input port 48A may itself form an optical splitter). MMI coupler 47 may also include an optical splitter 62 that is optically coupled to input port 48B (e.g., input port 48B may illuminate optical splitter 62 using the optical local oscillator signal LO2 on optical path 46B). Alternatively, optical splitter 62 may be integrated into input port 48B (e.g., input port 48B may itself form an optical splitter).

MMI coupler 47 may include a first optical path 52, a second optical path 54, a third optical path 56, and a fourth optical path 58 (e.g., formed from respective optical fibers, optical waveguides, or optical channels, which may, if desired, be disposed on or within a substrate of MMI coupler that is different than the substrates of laser modules 44A and 44B). Optical path 52 may couple optical splitter 60 to output port 50A of MMI coupler 47 (e.g., may optically couple optical splitter 60 and thus input port 48A and optical path 46A to output port 50A). Optical path 54 may couple optical splitter 62 to output port 50A of MMI coupler 47 (e.g., may optically couple optical splitter 62 and thus input port 48B and optical path 46B to output port 50A). Optical path 56 may couple optical splitter 60 to output port 50B of MMI coupler 47 (e.g., may optically couple optical splitter 60 and thus input port 48A and optical path 46A to output port 50B). Optical path 58 may couple optical splitter 62 to output port 50B of MMI coupler 47 (e.g., may optically couple optical splitter 62 and thus input port 48B and optical path 46B to output port 50B). If desired, MMI coupler 47 may include optical combiners at output terminals 50A and 50B (e.g., output terminals 50A and 50B may themselves include respective optical combiners if desired).

MMI coupler 62 may be configured to exhibit predetermined phase relationships between input port 48A, output port 50A, input port 48B, and output port 50B that cause MMI coupler 62 to exhibit relatively high optical isolation between its input ports 48A and 48B and thus between optical paths 46A and 46B and between lasers 42A and 42B (e.g., up to 100% isolation in an ideal case). The predetermined phase relationships may be set, for example, via corresponding selection of the optical lengths of optical paths 52 and 65 relative to the optical lengths of optical paths 54 and 58 (e.g., where controlling the ratio of optical lengths changes the phase relationships between the input ports and output ports). The predetermined phase relationships may, for example, include a first relative phasing φ1 between input port 48B and output port 50A, a second relative phasing φ2 between input port 48A and output port 50A, a third relative phasing φ3 between input port 48A and output port 50B, and a fourth relative phasing φ4 between input port 48B and output port 50B.

To maximize isolation between input ports 48A and 48B, MMI coupler 47 may be configured to exhibit a first phase PA at input port 48A, a second phase at input port 48B that is 180 degrees from phase PA (e.g., that is phase shifted from phase PA by 180 degrees), a third phase PB at output port 50B that is different from phase PA (e.g., that is 90 degrees greater than phase PA), and a fourth -PB at output port 50A that is the inverse of the phase PA of output port 50B. Put differently, input port 48A may have phase PA, input port 48B may have phase PA + 180 degrees, output port 50B may have phase PB (e.g., PA + 90 degrees), and output port 50A may have phase -PB (e.g., PA – 90 degrees). When configured in this way, relative phasing φ1 may be 90 degrees (e.g., given by the difference between the phases of ports 48B and 50A), relative phasing φ2 may be 90 degrees (e.g., given by the difference between the phases of ports 48A and 50A), relative phasing φ3 may be 90 degrees (e.g., given by the difference between the phases of ports 48A and 50B, and relative phasing φ4 may be 90 degrees (e.g., given by the difference between the phases of ports 50B and 48B). In an example where phase PA is zero degrees, for instance, the phase of input port 48B may be 180 degrees, the phase of output port 50A may be -90 degrees, and the phase of output port 50B may be 90 degrees. This is illustrative and, in practice, may be generalized to any desired phase PA of input port 48A.

During operation, input port 48A (e.g., optical splitter 60) may pass optical local oscillator signal LO1 (at phase PA) onto optical paths 52 and 56. Input port 48B (e.g., optical splitter 62) may concurrently pass optical local oscillator signal LO2 onto optical paths 54 and 58. Optical splitters 60 and 62 may be implemented as optical couplers if desired. Output port 50A and/or optically coupled segments of optical paths 52 and 54 may optically combine the optical local oscillator signal LO1 on optical path 52 with the optical local oscillator signal LO2 on optical path 54 to produce a corresponding optical signal OPTSIG that is output onto optical path 66 with phase -PB. Optical signal OPTSIG includes a combination (e.g., superposition) of optical local oscillator signal LO1 at frequency F1 and optical local oscillator signal LO2 at frequency F2. At the same time, output port 50B and/or optically coupled segments of optical paths 56 and 58 may optically combine the optical local oscillator signal LO1 on optical path 56 with the optical local oscillator signal LO2 on optical path 58 to produce a corresponding optical signal OPTSIG that is output onto optical path 68 with phase PB (e.g., the optical signal OPTSIG on optical path 68 may be the same optical signal as the optical signal OPTSIG on optical path 66 but with opposite phase).

Because input port 48B is 180 degrees out of phase with respect to input port 48A, any portion of optical local oscillator signal LO2 that passes from input port 48B onto input port 48A (e.g., due to optical coupling between segments of optical paths 52 and 54 and optical coupling between segments of optical paths 56 and 58 within MMI coupler 47) will destructively interfere or cancel out with a corresponding portion of optical local oscillator signal LO1 that passes from input port 48A onto input port 48B. This may effectively isolate optical path 46A and thus laser 42A from optical local oscillator signal LO2, optical path 46B, and laser 42B while also effectively isolating optical path 46B and thus laser 42B from optical local oscillator signal LO1, optical path 46A, and laser 42A (e.g., without requiring the use of bulky optical isolators).

Optical path 66 may couple output port 50A to an optical port 36 of signal generation circuitry 36 (e.g., an optical output port of signal generation circuitry 36). If desired, optical path 66 may output optical signal OPTSIG from signal generation circuitry 36 via optical port 64 (e.g., the optical signal OPTSIG output via output port 50A of MMI coupler 47 may form the signal SIG output by signal generation circuitry 36 as shown in FIG. 1). If desired, optical port 50A may optionally illuminate a photomixer 80 using optical signal OPTSIG (e.g., optical path 66 may couple output port 50A of MMI coupler 47 to an optical or active/photosensitive area of photomixer 80). Photomixer 80 may include an electrical terminal, contact, or node coupled to electrical path 78 (e.g., a radio-frequency transmission line).

Photomixer 80 may include, for example, an electro-optical heterodyning device (e.g., a square law device) such as a photodiode (e.g., a UTC-PD or another type of photodiode). Photomixer 80 may, for example, perform a square law or heterodyning operation on signal components at different frequencies (modes) in optical signal OPTSIG, which generates an electrical signal RFSIG on electrical path 78 as an electrical beat signal between the different frequencies/modes of optical signal OPTSIG (e.g., at a beat frequency given by differences between the wavelengths/frequencies of the different modes in optical signal OPTSIG). Because optical signal OPTSIG includes optical local oscillator signal LO1 at frequency F1 and optical local oscillator signal LO2 at frequency F2, electrical signal RFSIG (e.g., a radio-frequency signal) may be at a frequency F3 = |F2 - F1|. Lasers 42A and 42B may, for example, output optical local oscillator signals LO1 and LO2 at frequencies F1 and F2 that are selected to place frequency F3 at a desired radio-frequency (e.g., a sub-THz frequency for high data rate communications).

If desired, signal generation circuitry 36 may have an electrical output terminal coupled to electrical path 78 (e.g., electrical signal RFSIG may form the signal SIG output by signal generation circuitry 36 as shown in FIG. 1). If desired, wireless circuitry 24 (FIG. 1) may include an antenna resonating element such as antenna element 82 (e.g., one or more antenna arms, slot antenna elements, patch antenna elements, dipole antenna arms, monopole antenna arms, inverted-F antenna arms, bowtie antenna arms, etc.). Antenna element 82 may be coupled directly to electrical path 78 or may be directly connected to an electrical output terminal of photomixer 80. Antenna element 82 and optionally its corresponding photodiode 80 may, for example, form an antenna 30 in device 10 (FIG. 1). Antenna element 82 may radiate electrical signal RFSIG into free space (e.g., as wireless signal 32 of FIG. 1).

In these implementations, if desired, one or more optical phase shifters (not shown) may be disposed on optical path 46A and/or optical path 46B for performing optical phase shifts on one or both optical local oscillator signals, which may produce a corresponding electrical phase shift in electrical signal RFSIG allowing the electrical signal RFSIG radiated by antenna element 82 to be used in performing beam steering of a corresponding signal beam (e.g., in implementations where antenna element 82 is formed as a part of a phased antenna array). Additionally, or alternatively, one or more electro-optical modulators (not shown) such as Mach-Zender Modulators (MZMs) may be disposed on optical path 46A and/or optical path 46B for modulating wireless data onto one or both optical local oscillator signals (e.g., as received in an electrical signal supplied by a digital-to-analog converter in a transmit chain of wireless circuitry 24). Photomixer 80 may preserve the wireless data modulated onto the optical local oscillator signal(s) in the electrical signal RFSIG on electrical path 78 (e.g., allowing antenna element 82 to wirelessly convey the wireless data).

If desired, optional receiver circuitry such as receiver 81 (e.g., containing a downconversion circuitry, demodulator circuitry, analog-to-digital converter circuitry, optical receiver circuitry, intermediate frequency receiver circuitry, etc.) may be communicatively coupled to photomixer 80 over receive path 83. Receive path 83 may include one or more optical paths that are coupled to an optical portion of photomixer 80 and that convey optical signals or may include one or more electrical paths that convey electrical signals from photodiode 83 to receiver 81 (e.g., radio or intermediate frequency transmission line paths).

If desired, photomixer 80 may include a programmable photodiode such as a UTC PD that receives different bias voltages for switching the photodiode between a signal transmit mode and a signal receive mode. In the transmit mode (e.g., under a first bias voltage setting), photomixer 80 transmits electrical signal RFSIG on electrical path 78 and/or over antenna element 82 (e.g., antenna element 82 may radiate radio-frequency RFSIG). In the receive mode (e.g., under a second bias voltage setting), photomixer 80 receives electrical signal RFSIG from electrical path 78 and/or antenna element 82. Photomixer 80 may pass the received signal to receiver 81 over signal path 83 as an electrical signal or as an optical signal (e.g., photomixer 80 may exhibit one or more modes in which the photomixer converts a received electrical signal into optical energy on signal path 83).

If desired, antenna element 82, electrical path 78, photomixer 80, signal path 83, and/or receiver 81 may be omitted. If desired, signal generation circuitry 36 may optionally include a phase-locked loop (PLL) path coupled between output port 50B of MMI coupler 47 and actuator 84 on optical resonator 40B (e.g., to help phase lock laser 42A to laser 42B and to minimize phase noise and jitter in the signal SIG (FIG. 1) output by signal generation circuitry 36). For example, as shown in FIG. 2, signal generation circuitry 36 may include a PLL path that includes optical path 68, photomixer 70, electrical path 72, and PLL circuitry 74 coupled together in a loop around MMI coupler 47.

Optical path 68 may couple output port 50B of MMI coupler 47 to an optical or active/photosensitive area of photomixer 70 (e.g., optical path 68 may illuminate photomixer 70 using optical signal OPTSIG). Photomixer 70 may include an electrical terminal, contact, or node coupled to electrical path 72. Electrical path 72 may include, for example, a radio-frequency transmission line path coupled between photomixer 70 and PLL circuitry 74 and may include a control path (e.g., a baseband path, an analog control path, a digital control path, etc.) coupled between PLL circuitry 74 and actuator 84.

Photomixer 70 may include, for example, an electro-optical heterodyning device (e.g., a square law device) such as a photodiode (e.g., a UTC-PD or another type of photodiode). Photomixer 70 may, for example, perform a square law or heterodyning operation on signal components at different frequencies (modes) in optical signal OPTSIG, which generates an electrical signal ESIG on electrical path 72 as an electrical beat signal between the different frequencies/modes of optical signal OPTSIG (e.g., at a beat frequency given by differences between the wavelengths/frequencies of the different modes in optical signal OPTSIG). Because optical signal OPTSIG includes optical local oscillator signal LO1 at frequency F1 and optical local oscillator signal LO2 at frequency F2, electrical signal ESIG (e.g., a radio-frequency signal) may be at a frequency F3 = |F2 - F1|.

If desired, optical path 68 may output optical signal OPTSIG from signal generation circuitry 36 via an optical port (not shown) on optical path 68 (e.g., the optical signal OPTSIG output via output port 50B of MMI coupler 47 may form the signal SIG output by signal generation circuitry 36 as shown in FIG. 1). If desired, signal generation circuitry 36 may have an electrical output terminal (not shown) coupled to electrical path 72 (e.g., electrical signal EFSIG may form the signal SIG output by signal generation circuitry 36 as shown in FIG. 1). If desired, antenna element 82, signal path 83, and/or receiver 81 may be coupled to photomixer 70 instead of photomixer 80.

Electrical path 72 may convey electrical signal ESIG to PLL circuitry 74. PLL circuitry 74 may include any desired PLL circuitry and/or frequency locked loop (FLL) circuitry such as one or more dividers, phase detectors, subsampling mixers, loop filters, counters, digital-to-time converters (DTCs), electrical-to-optical converters, optical-to-electrical converters, photomixers, electro-optical modulators, controllers, comparators, electrical paths, optical paths, etc. If desired, the operations of PLL circuitry 74 may be clocked using a clock signal such as oscillating signal OSC output by reference oscillator 76 (e.g., a crystal oscillator). PLL circuitry 74 may generate an electrical control signal such as control signal CTRL based on the electrical ESIG output by photomixer 70 and based on oscillator signal OSC. Electrical path 72 may provide control signal CTRL to the actuator 84 of optical resonator 40B over a control line in electrical path 72. Control signal CTRL may control actuator 84 to adjust the optical resonance of optical resonator 40B, which adjusts the self-injection locking of laser 42B to set the frequency F2 of laser 42B close to or inside the locking range of PLL circuitry 74 (e.g., until a phase error measured by the PLL circuitry is minimized). This may configure laser 42B to produce an optical local oscillator LO2 that is phase locked with optical local oscillator signal LO1 (e.g., in a desired phase and/or frequency relationship) with minimal phase noise and jitter. This is illustrative and non-limiting. If desired, optical path 68, photomixer 70, electrical path 72, reference oscillator 76, PLL circuitry 74, and/or actuator 84 may be omitted.

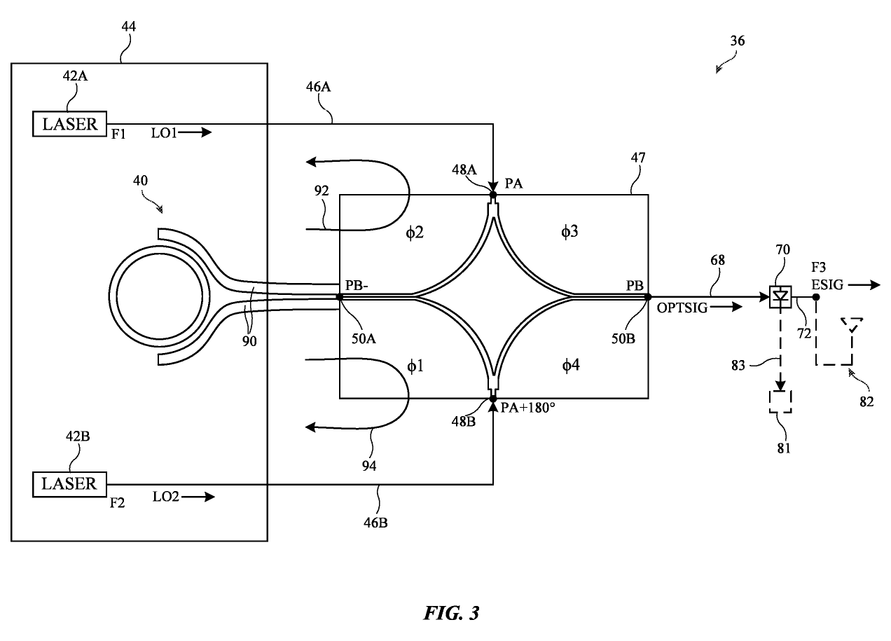

In example of FIG. 2, lasers 42A and 42B are self-injection locked to different optical resonators 40A and 40B, which may allow for high tunability and low phase noise in the signal SIG output by signal generation circuitry 36. To further increase the quality factor (Q) of the signal SIG output by signal generation circuitry 36, lasers 42A and 42B may be self-injection locked to the same optical resonator 40 (e.g., in a dual self-injection locking or dual-injection locking scheme). FIG. 3 shows another example in which lasers 42A and 42B are self-injection locked to the same optical resonator 40. As shown in FIG. 3, lasers 42A and 42B may be integrated into and/or disposed on the same laser module 44 as a single optical resonator 40 that is shared by both lasers 42A and 42B. Output port 50A of MMI coupler 47 may be coupled to one or more optical paths 90. Optical path(s) 90 may optically couple output port 50A of MMI coupler 47 to optical resonator 40 or may form a part of optical resonator 40 that is optically coupled to the optical ring in optical resonator 40.

Prior to self-injection locking, optical local oscillator signal LO1 may pass from optical path 46A into MMI coupler 47 through input port 48A and optical local oscillator signal LO2 may pass from optical path 46B into MMI coupler 47 through input port 48B. MMI coupler 47 may pass optical local oscillator signal LO1 from input port 48A onto output port 50A, which passes the optical local oscillator signal to optical resonator 40. Optical resonator 40 may resonate with optical local oscillator signal LO1 (e.g., as described above in connection with optical resonator 40A) and may reflect optical local oscillator signal LO1 back onto output port 50A. As shown by arrow 92, the reflected optical local oscillator signal LO1 passes from output port 50A, through MMI coupler 47, and back onto optical path 46A via input port 48A (e.g., output port 50A may form an input port of MMI coupler 47 and input port 48A may form an output port of MMI coupler 47 from the perspective of reflected optical local oscillator signal LO1). Optical path 46A propagates the reflected optical local oscillator signal LO1 back into laser 42A to self-injection lock laser 42A. Because of the high isolation between input ports 48A and 48B (e.g., due to the predetermined phasing of MMI coupler 47), very little or none of the reflected optical local oscillator signal LO1 passes from output port 50A onto input port 48B of MMI coupler 47 (e.g., preserving isolation between lasers 42A and 42B).

At the same time, MMI coupler 47 may pass optical local oscillator signal LO2 onto output port 50A from input port 48B, which passes the optical local oscillator signal to optical resonator 40. Optical resonator 40 may resonate with optical local oscillator signal LO2 (e.g., as described above in connection with optical resonator 40B) and may reflect optical local oscillator signal LO2 back onto output port 50B. The dimensions of the optical ring in optical resonator 40 may, for example, be selected to resonate at the frequencies of both optical local oscillator signals LO1 and LO2. As shown by arrow 94, the reflected optical local oscillator signal LO2 passes from output port 50A, through MMI coupler 47, and back onto optical path 46B via input port 48B (e.g., output port 50A may form an input port of MMI coupler 47 and input port 48B may form an output port of MMI coupler 47 for reflected optical local oscillator signal LO2). Optical path 46B propagates the reflected optical local oscillator signal LO2 back into laser 42B to self-injection lock laser 42B. Because of the high isolation between input ports 48A and 48B (e.g., due to the predetermined phasing of MMI coupler 47), very little or none of the reflected optical local oscillator signal LO2 passes from output port 50A onto input port 48A of MMI coupler 47 (e.g., preserving isolation between lasers 42A and 42B).

In these implementations, optical path 68, photomixer 70, and/or electrical path 72 may be communicatively coupled to output port 50B if desired. If desired, PLL circuitry (FIG. 2) may be coupled between photomixer 70 and an actuator on optical resonator 40 (e.g., as shown by PLL circuitry 74 and actuator 84 of FIG. 2)). If desired, antenna element 82, signal path 83, and/or receiver 81 may be coupled to photomixer 70 in these implementations. If desired, optical path 68, photomixer 70, signal path 83, receiver 81, antenna element 82, and/or electrical path 72 may be omitted in these implementations. When configured in this way, lasers 42A and 42B may share one optical resonator 40 (e.g., reducing area consumption) for fixed frequency generation with increased noise suppression (e.g., due to noise correlation). Signal generation circuitry 36 of FIG. 3 may, for example, exhibit leakage suppression by up to 15 dB, independent laser performance and biasing, and robust operation even for low frequencies F3 (e.g., less than 100 GHz) without four-wave mixing (e.g., due to the isolation supplied by MMI coupler 47).

The examples of FIGS. 2 and 3 in which MMI coupler 47 is a two-by-two port coupler is illustrative and non-limiting. In general, MMI coupler 47 may have any desired number of two or more input ports 48 and/or two or more output ports 50 (e.g., may be an M-by-N port coupler having M input ports and N output ports). As another example, MMI coupler 47 may have four input ports and four output ports (e.g., may be implemented as a four channel MMI). If desired, each of the M input ports may receive a respective one of M optical signals from a respective one of M lasers over a respective one of M optical paths. If desired, the MMI coupler may output a combination of the M optical signals over one or more (e.g., all) of its N output ports. The MMI coupler may have the predetermined phase relationship described above between its input ports (e.g., to exhibit the isolation between input ports as described above) and/or output ports. Unlike an optical resonator, MMI coupler 47 is a non-magnetic component (e.g., does not include any magnets). MMI coupler 47 is sometimes also referred to herein as non-magnetic MMI coupler 47.

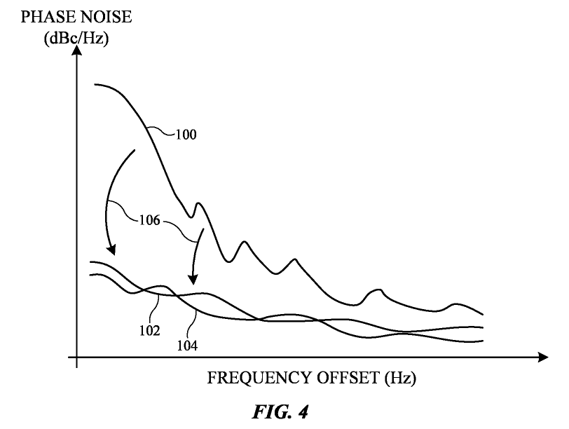

FIG. 4 is a plot showing how signal generation circuitry 36 may mitigate phase noise in signal SIG (e.g., in implementations where lasers 42A and 42B share optical resonator 40 as shown in FIG. 3). The vertical axis of FIG. 4 plots phase noise in dBc/Hz. The horizontal axis of FIG. 4 plots frequency offset (e.g., on a logarithmic scale). Curve 100 plots phase noise of laser 42A while free running. Curve 102 plots the phase noise of laser 42A after self-injection locking to optical resonator 40 through MMI coupler 47. Curve 104 plots the phase noise of laser 42B after self-injection locking to the same optical resonator 40 through MMI coupler 47. As shown by arrows 106, self-injection locking to the same optical resonator 40 through MMI coupler 47 may substantially reduce phase noise for both lasers. This reduction in phase noise may be maintained in the signal SIG output by signal generation circuitry 36 based on optical local oscillator signals LO1 and LO2. FIG. 4 is illustrative and non-limiting. Curves 100-104 may have other shapes in practice.

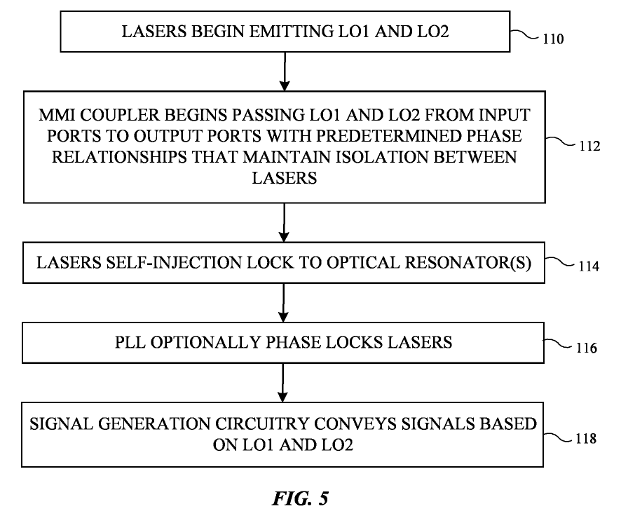

FIG. 5 is a flow chart of illustrative operations that may be performed by communications circuitry 20 (FIG. 1) to transmit signals using signal generation circuitry 36 of FIGS. 2 and 3. At operation 110, lasers 42A and 42B may be turned on and may begin emitting respective optical local oscillator signals LO1 and LO2 onto optical paths 46A and 46B. Lasers 42A and 42B may continue to output optical local oscillator signals LO1 and LO2 while processing the remaining operations of FIG. 5.

At operation 112, MMI coupler 47 may begin passing optical local oscillator signal LO1 from input port 48A onto output ports 50A and 50B and may begin passing optical local oscillator signal LO2 from input port 48B onto output ports 50A and 50B, with predetermined phase relationships that maintain high (e.g., maximum) isolation between input ports 48A and 48B (e.g., as described above in connection with FIGS. 2 and 3). MMI coupler 47 may continue to couple optical local oscillator signal LO1 from input port 48A onto output ports 50A and 50B and may continue to couple optical local oscillator signal LO2 from input port 48B onto output ports 50A and 50B while processing the remaining operations of FIG. 5.

At operation 114, lasers 42A and 42B may self-injection lock to one or more optical resonators 40. For example, laser 42A may self-injection lock to optical resonator 40A of FIG. 2 while laser 42B self-injection locks to optical resonator 40B of FIG. 2. As another example, lasers 42A and 42B may dual self-injection lock to optical resonator 40 of FIG. 3.

At optional operation 116, PLL circuitry 74 may phase lock lasers 42A and 42B together to help reduce phase noise and jitter. Operation 116 may be omitted if desired.

At operation 118, communications circuitry 20 may perform any desired transmission or reception of or using the signal SIG produced by signal generation circuitry 36 (e.g., based on the optical local oscillator signals LO1 and LO2 output by lasers 42A and 42B). Signal SIG may exhibit relatively low phase noise and jitter and signal generation circuitry 36 may consume as little area in communications circuitry 20 as possible.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Devices 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. Communication circuitry comprising:
a first laser;
a second laser;
a multi-mode interference (MMI) coupler having a first input port, a second input port, a first output port, and a second output port;
a first optical path that couples an output of the first laser to the first input port of the MMI coupler;
a second optical path that couples an output of the second laser to the second input port of the MMI coupler; and
a first optical resonator disposed on the first optical path.

2. The communication circuitry of claim 1, further comprising:
a second optical resonator disposed on the second optical path.

3. The communication circuitry of claim 2, wherein the first optical resonator is configured to self-injection lock the first laser and the second optical resonator is configured to self-injection lock the second laser.

4. The communication circuitry of claim 3, wherein the second optical resonator comprises an optical loop and an actuator coupled to the optical loop, the communication circuitry further comprising:
phase-locked loop (PLL) circuitry communicatively coupled between the first output port of the MMI coupler and the actuator.

5. The communication circuitry of claim 4, further comprising:
a first photomixer;
a third optical path that couples the first output port of the MMI coupler to the first photomixer;
an electrical path that communicatively couples the first photomixer to the actuator, wherein the PLL circuitry is disposed on the electrical path; and
a reference oscillator configured to clock the PLL circuitry.

6. The communication circuitry of claim 5, further comprising:
a second photomixer;
a fourth optical path that couples the second photomixer to the second output port of the MMI coupler; and
an antenna element communicatively coupled to the second photomixer.

7. The communication circuitry of claim 1, wherein the first laser is configured to output a first optical signal at a first frequency onto the first optical path, the second laser is configured to output a second optical signal at a second frequency onto the second optical path, and the second frequency is different from the first frequency.

8. The communication circuitry of claim 7, wherein the MMI coupler comprises:
a third optical path that couples the first input port to the first output port;
a fourth optical path that couples the second input port to the first output port;
a fifth optical path that couples the first input port to the second output port; and
a sixth optical path that couples the second input port to the second output port.

9. The communication circuitry of claim 8, wherein:
the MMI is configured to exhibit a first phase at the first input port, a second phase at the second input port, a third phase at the first output port, and a fourth phase at the second output port,
the second phase is 180 degrees from the first phase, and
the fourth phase is an inverse of the third phase.

10. The communication circuitry of claim 9, wherein:
the third phase is 90 degrees less than the first phase, and
the fourth phase is 90 degrees greater than the first phase.

11. The communication circuitry of claim 9, further comprising:
a photodiode;
a fifth optical path that couples the first output port of the MMI coupler to the photodiode; and
an antenna element communicatively coupled to the photodiode, wherein the photodiode is configured to receive the first optical signal and the second optical signal via the first output port of the MMI coupler, the photodiode is configured to generate an electrical signal on the antenna element based on the first optical signal and the second optical signal, and the antenna element is configured to radiate a wireless signal based on the electrical signal, the electrical signal and the wireless signal being at a third frequency equal to a difference between the first frequency and the second frequency.

12. The communication circuitry of claim 1, wherein the MMI coupler is non-magnetic and comprises at least one additional input port and at least one additional output port.

13. Communication circuitry comprising:
a first laser;
a second laser;
a multi-mode interference (MMI) coupler having a first input port, a second input port, a first output port, and a second output port;
a first optical path that couples an output of the first laser to the first input port of the MMI coupler;
a second optical path that couples an output of the second laser to the second input port of the MMI coupler; and
an optical resonator coupled to the first output port of the MMI coupler.

14. The communication circuitry of claim 13, wherein:
the optical resonator is configured to self-injection lock the first laser through the MMI coupler and the first optical path, and
the optical resonator is configured to self-injection lock the second laser through the MMI coupler and the second optical path.

15. The communication circuitry of claim 13, wherein the MMI coupler comprises at least one additional input port and at least one additional output port.

16. The communication circuitry of claim 13, wherein the first laser is configured to output a first optical signal at a first frequency, the second laser is configured to output a second optical signal at a second frequency that is different from the first frequency, and the communication circuitry further comprises:
a photomixer;
a third optical path that couples the second output port of the MMI coupler to the photomixer; and
an antenna element communicatively coupled to the photomixer, wherein
the MMI coupler is configured to pass the first optical signal from the first input port to the first output port and the second output port of the MMI coupler,
the MMI coupler is configured to pass the second optical signal from the second input port to the first output port and the second output port of the MMI coupler,
the third optical path is configured to illuminate the photomixer using the first optical signal and the second optical signal,
the photomixer is configured to produce a current on the antenna element based on the first optical signal and the second optical signal,
the antenna is configured to radiate a radio-frequency signal based on the current, and
the radio-frequency signal is at a third frequency equal to a difference between the second frequency and the first frequency.

17. The communication circuitry of claim 13, wherein the MMI coupler is configured to:
exhibit a first phase at the first input port;
exhibit a second phase at the second input port, the second phase being 180 degrees from the first phase,
exhibit a third phase at the first output port that is different from the first phase and the second phase, and
exhibit a fourth phase at the second output port that is an inverse of the third phase.

18. An electronic device comprising:
a non-magnetic multi-mode interference (MMI) coupler having a first input port, a second input port that exhibits a 180 degree phase difference from the first input port, a first output port, and a second output port that exhibits an inverse phase of the first output port;
a first laser configured to supply a first optical signal at a first frequency to the first input port of the non-magnetic MMI coupler;
a second laser configured to supply a second optical signal at a second frequency to the second input port of the non-magnetic MMI coupler, wherein the non-magnetic MMI coupler is configured to output the first optical signal and the second optical signal at the first output port;
circuitry configured to convey data based on the first optical signal and the second optical signal output at the first output port by the non-magnetic MMI coupler; and
one or more optical resonators configured to self-injection lock the first laser and the second laser.

19. The electronic device of claim 18, the one or more optical resonators comprising:
a single optical resonator coupled to the second output port of the non-magnetic MMI coupler and configured to self-injection lock both the first laser and the second laser.

20. The electronic device of claim 18, the one or more optical resonators comprising:
a first optical resonator coupled between the first laser and the first input port of the non-magnetic MMI coupler, the first optical resonator being configured to self-injection lock the first laser; and
a second optical resonator coupled between the second laser and the second input port of the non-magnetic MMI coupler, the second optical resonator being configured to self-injection lock the second laser.
